(19) United States
(12) Patent Application Publication
(10) Pub. No.: US 2006/0032572 A1
(43) Pub. Date: Feb. 16, 2006

(54) Body-contact protective interface structure with neutral internal adhesive interface

(75) Inventors: Michael R. Dennis, Scappoose, OR (US); Michael Tucker, Beaverton, OR (US); Gerhard Paasche, Scappoose, OR (US)

Correspondence Address: ROBERT D. VARITZ, P.C., 4915 SE 33RD PLACE, PORTLAND, OR, 97202, US

(73) Assignee: MJD Innovations, L.L.C.

(21) Appl. No.: 11/257,617

(22) Filed: Oct. 25, 2005

Related U.S. Application Data
(62) Division of application No. 10/843,819, filed on May 11, 2004.

(51) Int. Cl. B31B 1/60; B32B 37/00

(52) U.S. Cl. 156/60

(57) ABSTRACT

A method for fabricating a plural-layer, body-contacting protective and cushioning interface structure including the steps of (a) providing at least a pair of viscoelastic, non-springy, acceleration-rate-sensitive core layers, (b) facially bonding these two core layers using curable and initially wet, flowable adhesive which is based upon a solvent of one character, and thereafter (c) completing the fabrication by the application of a curable, and initially wet, flowable barrier-layer material to form a fully moisture-impervious but gas-permeable coating barrier layer which substantially completely encloses the bonded core layers.

### CROSS REFERENCE TO RELATED APPLICATION

This is a division of prior-filed, currently co-pending U.S. patent application Ser. No. 10/843,819, filed May 11, 2004, for “Body-Contact Protective Interface Structure With Neutral Internal Adhesive Interface”. The entire disclosure content of this prior-filed application is hereby incorporated herein by reference.

### BACKGROUND AND SUMMARY OF THE INVENTION

The present invention relates to a human-body-contact, protective cushioning interface structure, and to a method for making this structure. A preferred and best-mode embodiment of, and manner of practicing, the invention are described herein, for illustration purposes, in the context of an end-result cushioning structure which is somewhat like the cushioning structure described in U.S. Pat. No. 6,467,099 B2—a context wherein the features of this invention, structural and methodological, have been found to offer particular utility. Accordingly, the disclosure content of this prior-issued patent is hereby incorporated herein by reference.

Thus, the invention is illustratively described herein in relation to an interface structure, and to the making of such a structure, which is designed to be comfortably interposed the human body and something external to the body for the purpose of absorbing and minimizing various kinds of dynamic loads, such as shock loads, while at the same time not introducing any appreciable “use discomfort” issues. While there are many applications wherein the interface structure and the associated methodology of the present invention can offer distinct advantages, one preferred embodiment of, and manner of making (fabricating), the invention are described herein specifically in the setting of a military helmet with respect to which the invention has been found to furnish special utility both with respect to its shock-handling and to its “comfort-respecting” capabilities.

The conventional “military-helmet” use environment, and in particular that phase of such an environment which involves relatively long-term, and relatively strenuous and/or abusive, use, provides a setting which is very demonstrative of the issues that are successfully addressed by the present invention. A typical military infantry helmet utilizes an internal webbing system combined with a removable leather (or the like) liner to suspend the helmet on the wearer's head. While the usual airspace which exists between the webbing system and the shell of the helmet contributes to both the helmet's overall ballistic and cooling capabilities, most users recognize that there is significant room for improvements to be made. While cooling and associated comfort factors are certainly always worth improving, perhaps most important is the critical issue of shock-absorption safety, and in particular, reliable safety over long spans of time, and under a wide range of abusive use and threat conditions, such as are experienced by the military.

In response recently to these “improvement” considerations, the special cushioning structure illustrated and described in the above-mentioned U.S. Patent has been developed, and has proven to be not only an impressive contributor to user comfort, but also an extraordinary “safety performer” in numerous severe, traumatic-event situations. Its various shock-management features have garnered wide-spread praise for their abilities to shroud users against serious injuries in many dangerous situations.

In certain applications, which help to illustrate the advantages offered by the present invention, the relevant shock-absorbing structural features of this cushioning structure are provided/supported by a pair of surface-adhesive-bonded, differentiated-durometer, core cushioning elements—and in particular core cushioning layers which co-act in special ways in response to high-acceleration shock loads. These bonded core layers are jacketed by a special, and importantly contributive, moisture-impervious but gas-permeable barrier layer. In many, if not most, of these “certain” applications, the cooperative adhesive-bonded interface between core layers has proven to be stable and contributive to shock-management behavior. However, there are certain long-term applications wherein this bonded interface has shown a specific need for improvement in order to offer longer than usual, high-performance integrity.

What has been determined, regarding this desire for inter-layer bonding improvement to meet special situations, is that there is an important interactive relationship deserving attention which exists between the nature of the adhesive that is employed to bond the adjacent cushioning core layers, and the nature of the mentioned over-covering barrier-layer material. According to sensible fabrication practices, both of these materials (adhesive and barrier-layer materials) are introduced during interface-structure fabrication as liquid-flowable, solvent-based, subsequently “curable” substances. The inter-layer adhesive bonding material selected preferably in the past has been methylene-chloride (solvent) based, and the selected barrier-layer material has been acetone (solvent) based.

More particularly, an inter-core-layer adhesive product which has been employed heretofore has been an adhesive known as Permagrip, made by Imperial Adhesives. The barrier-layer material has preferably been either one of two different products, one of which is known as Russell Coating, sold under the product designator V-2000, and made by Russell Products Company, Inc. of Akron, Ohio, and the other of which is known as Muraculon PDC F-830, made by Plasti Dip International of Blaine, Minn.

During normal fabrication sequence, and where a two-layer core is to be employed, one face of each of two, different-durometer, core-layer sheets is initially treated with a layer of barrier material. Thereafter, adhesive is applied to one or both of the other sheet faces, and these faces are brought together to unite (bond) the two sheets.

After the inter-layer bonding adhesive has been applied between the core layers, and these layers have been adhered to one another, as just generally outlined, the layered core structure is perimeter-cut to shape(s), and then, with respect to the exposed cut edges of this shape, or of these shapes, there is a final edge-covering, over-coating step performed involving the further application of barrier-layer material.

In this setting, a certain level of “compatible” and potentially destructive interactive “engagement”, which is illusive in may ways, has recently been discovered to occur occasionally between these two materials (adhesive and barrier-layer materials), with vaporizing of the acetone solvent in the barrier-layer material causing an interactive degradation to take place in regions of the methylene-chloride-based bonding adhesive layer which resides between the core cushioning layers. Over a sufficiently long time, this interactive phenomenon can cause debonding of the cushioning layers, with a resultant degradation of overall cushioning performance. The “solvencies”, so-to-speak, of these two materials have thus been found to be capable, at times, but nominally only after relatively long periods of “normalcy”, of creating a functional degradation of overall device performance and reliability. Long-term strenuous use of such cushioning structures, such as that which characterizes use in the military, seems to exacerbate the noticed degradation problem.

The present invention is based upon this unusual-problem discovery, and implementation of the invention, as proposed herein, effectively eliminates the problem. In the bargain, the invention not only furnishes a clearly long-term-use improvement in the type of cushioning structure mentioned, but also provides a cushioning structure which retains all of the important, special, shock-managing performance of the cushioning structure per se as described in the identified issued patent.

According to a preferred and best-mode embodiment of the invention, what is proposed thereby is a cushioning interface structure which includes a plural-cushioning-layer core, wherein next-adjacent core layers, which are formed each of a viscoelastic, anti-spring-back, acceleration-rate-sensitive material, are surface-bonded to one another through a solvent-based adhesive whose solvency is incompatible with, and thus un-affected by, the solvent base of an over-coating, substantially fully enveloping, gas-breathable, but moisture-impervious, barrier layer.

According to a preferred and best-mode manner of practicing the invention, the core-layer bonding adhesive, and the final-overcoating barrier-layer material, each is applied during device fabrication, as a wet, flowable, curable substance, with the bonding-adhesive material preferably being water-based, and the barrier-layer material preferably being acetone-based. The final edge overcoating of barrier-layer material is applied after application of the adhesive-bonding material and cutting of the layered core material to shape(s).

Utilization of the steps, and the end-result structure, of the present invention effectively eliminate the possibility of the performance-degradation problem mentioned above.

The various features and advantages offered and attained by invention will become more fully apparent as the description which now follows is read in conjunction with the accompanying drawings.

### DESCRIPTION OF THE DRAWINGS

FIG. 1 is a front elevation (with certain portions broken away to reveal details of internal construction) of a military helmet which is equipped with plural pad-like expanses (seven in total number) of layered, body-protective, cushioning interface structures constructed and fabricated in accordance with a preferred and best-mode embodiment of, and manner of practicing, the present invention.

FIG. 2 is a side elevation (also with portions broken away to reveal internal construction) of the helmet of FIG. 1, presented on about the same scale used in, and taken generally from the right side of, FIG. 1, with this helmet being tilted slightly toward the viewer.

FIG. 3 is an enlarged-scale, fragmentary detail taken generally in the area of curved arrow 3-3 in FIG. 2, showing, in general cross section, one of the interface structures employed in the helmet of FIGS. 1 and 2.

FIG. 4 is an enlarged, fragmentary detail which further illustrates internal construction of the interface structures shown in FIGS. 1-3, inclusive, particularly picturing very clearly the presence, between a pair of next-adjacent, different-durometer, core cushioning layers, of a bonding adhesive which is based upon a solvent that differs, in an incompatibility sense, from the solvent on which an outer, covering barrier layer is based.

### DETAILED DESCRIPTION OF, AND BEST MODE FOR CARRYING OUT, THE INVENTION

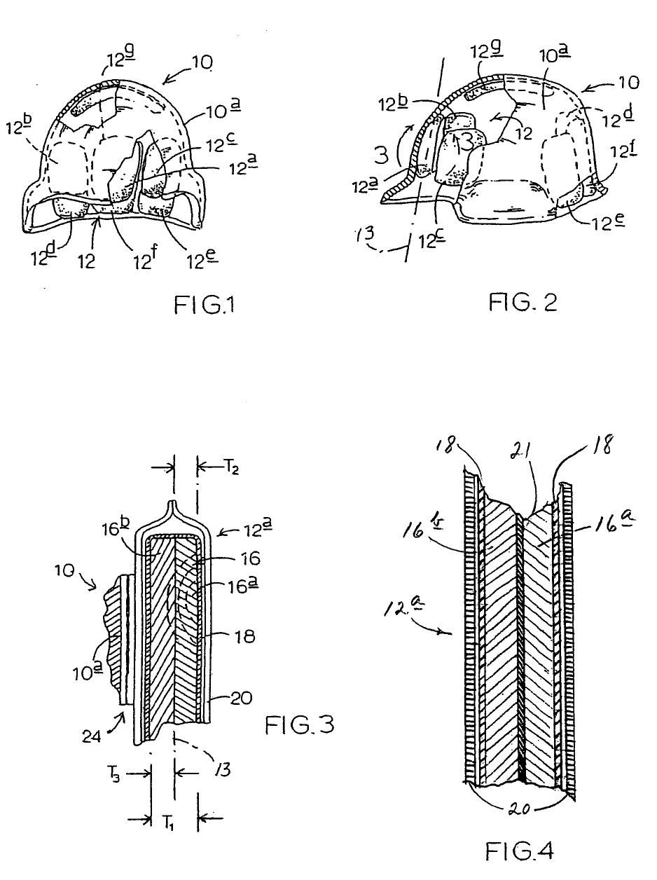

Turning attention now to FIGS. 1, 2 and 3, while the present invention is focused on the construction and making of a cushioning interface structure per se, it is specifically disclosed herein along with a suitable full description of a military helmet-use environment in order that its important features can readily be appreciated. Thus, indicated generally at 10 is a military helmet which includes a shell 10a. In all respects, shell 10a is completely conventional in construction, and might have any one of a number of different specific constructions and configurations. Fastened in a manner (not relevant to the present invention) that will shortly be described on the inside, concave, dome-like wall of shell 10a is an installation 12 of plural, body-protective interface structures which are constructed in accordance with a preferred and best-mode embodiment of the present invention. These structures have been fabricated in accordance with the methodology of the invention. Installation 12, in the particular setting illustrated in these three figures now being discussed, includes seven, individual, multi-layer, cushioning interface-structure pads 12a, 12b, 12c, 12d, 12e, 12f, 12g, each of which is constructed with a preferred form of a layered-assembly proposed by the present invention. Each such pad is also referred to herein as a body-protective, cushioning interface structure. Pad 12a is joined to the inside wall of shell 10a in the frontal, central portion of that wall, pads 12b, 12c on laterally opposite sides of pad 12a, pads 12d, 12e in laterally spaced locations on the inside, lower, rear portion of the inside wall of shell 10a, pad 12f centrally between pads 12d, 12e, and pad 12g on the upper (or crown) portion of the inside wall of shell 10a.

The perimetral shapes and the locations of these seven pads, and indeed the specific number of pads chosen for use in a helmet, such as in helmet 10, are completely matters of choice, and form no part of the present invention. These specific shapes, locations, and this number, have been chosen in relation to equipping helmet 10 (for illustration purposes herein) with an appropriate body-protective interface structure that acts between a wearer's head and helmet shell 10a.

A description of pad 12a which now follows, with regard to the layered construction (or assembly) of the pad, fully describes the construction of each of the other six pads in installation 12. It is useful to lead into this discussion by first explaining generally the different orientations of pad 12a that appear, respectively, in FIGS. 2 and 3. Pad 12a, as shown in FIG. 2, has a somewhat planar configuration, and appears to lie generally in a plane 13 (shown in dash-dot lines) which slopes upwardly and to the right in FIG. 2. In FIG. 3, plane 13 is rotated slightly counterclockwise so that it appears to be vertical.

Accordingly, and focusing attention now on FIG. 3 along with FIGS. 1 and 2, pad 12a as illustrated herein includes (a) a plural-layer cushioning core structure 16 which is made up of two layers 16a, 16b, (b) a moisture-impervious, gas-permeable, over-coating and substantially fully surrounding barrier layer 18, and (c) a moisture-wicking outer jacket 20. Jacket 20 does not form any part to the present invention. The right side of pad 12a in FIG. 3 is referred to herein as the body-facing side, and the left side of the pad in this figure as the load-facing side.

Each of the two layers (16a, 16b) which makes up core structure 16 is formed of a suitable anti-spring-back (low spring rate), acceleration-rate-sensitive, viscoelastic material, such as a viscoelastic urethane material, which possesses, in technical terms known to those skilled in art, in addition to the already mentioned characteristic of (a) acceleration-rate sensitivity, the additional characteristics of (b) temperature sensitivity and (c) pressure sensitivity. With regard to acceleration-rate sensitivity, the materials in layers 16a, 16b respond to compressive accelerations each with a resistance behavior that is likenable generally to the sheer-resistance behavior which is observed in certain fluids as a phenomenon known as fluid dilatancy. When compressive pressure is applied to these materials, if that pressure application is done at a very low acceleration rate, the materials respond very readily and fairly instantaneously with a yielding response. However, if such a pressure is applied rapidly, i.e., with a rapid acceleration rate, the materials tend to act very much like solids, and they do not respond rapidly with a yielding action. Generally speaking, the higher the rate of acceleration associated with an applied compressing force, the more like a solid material do layers 16a, 16b perform. An important consequence of this acceleration response characteristic is that the structure of the invention offers, in relation to most conventional prior art structures, a superior shock-cushioning action. Because of this, and because of the preferred selection of layer materials which also have almost no spring-back characteristic, the core structure offers significant shock-injury protection. An important and just-reiterated contributing factor in this regard is that the materials in layers 16a, 16b, because of their preferred lack of any appreciable spring-back behavior after undergoing a compressive deformation, return very slowly toward their pre-deformation configurations.

While there are, and may be, various appropriate acceleration-rate-sensitive, low-spring-rate materials that are employable in the practice of the invention, the description which follows herein is written in terms of a particular viscoelastic material which performs very admirably.

The two-layer make-up of core structure 16 is further characterized by the fact that the acceleration-rate-sensitive, viscoelastic material in layer 16a has a lower durometer and Indentation Load Deflection (ILD) response number than does the material in layer 16b. Specifically, and in the construction now being described, layer 16a has a durometer with an ILD number (or rating) preferably in the range of about 15 to about 28, and layer 16b a durometer with an ILD rating preferably in the range of about 42 to about 55. Layer 16a herein is made of a viscoelastic material designated as Confor CF-40, made by a company called EAR Specialty Composites in Indianapolis, Ind. Layer 16b is made of a viscoelastic material designated as Confor CF-45, also made by this same company.

The overall thickness of core structure 16, i.e. the dimension thereof measured laterally (or from left to right sides) in FIG. 3 (shown at T₁), is about ⅞-inches. Layer 16a has a thickness pictured in FIG. 3 at T₂ (measured in the same fashion) of about ⅜-inches, and layer 16b, a thickness pictured in FIG. 3 at T₃ of about ½-inches.

Within the context of a two-layer make-up for core structure 16, and with respect to an overall core structure thickness which is greater than about ½-inches, it is preferable that the thickness of layer 16a be maintained at no less than about ⅜-inches.

Under all circumstances, it is preferable, that the layer therein which is toward the body-facing side of the whole assembly have the lowest durometer number associated with it.

Another consideration regarding the structure of core structure 16 is that, preferably, it have a quite uniform thickness throughout. Uniformity of thickness plays an important role in maximizing the capability of this core structure to conform as precisely as possible with, in the case of a helmet, the topography of the wearer's head. Our practice has been to create such a core structure with an overall thickness which lies within a tolerance range of about ±0.002-inches. This is the thickness tolerance which characterizes the core structure pictured in helmet 10.

Within the three-dimensional body of each of the layers per se in core structure 16, there is no other structure present, save ambient and entrained gas. Accordingly, each such layer responds substantially uniformly, and omnidirectionally, throughout its entirety.

Adding reference now to FIG. 4, the structural organization which has been described so far herein is similar to that which is presented in the earlier-mentioned U.S. Patent, but the overall structure of the present invention is quite different with respect to the specific and relational structural content of a bonding-adhesive layer 21 which exists between next-adjacent layers 16a, 16b in core structure 16, in association with previously mentioned barrier layer 18. Appropriate, integrity-maintaining bonding is required between layers in a plural-layer core structure of the type described herein in order for the materials which make up this core structure to cooperate over long periods of time most effectively in handling and dissipating shock loads. The special relational association of layers 18, 21 in the structural organization of the present invention departs significantly from the past by recognizing that the interlayer debonding problem mentioned earlier, which has been known to occurs in the interfacial regions between next-adjacent core structure layers, and which challenges such desired integrity, can be resolved by selecting for use there an otherwise appropriately effective bonding adhesive which is further characterized by a solvent base which is incompatible with that of the barrier layer.

We have found that an extremely effective “solvent differentiation” can be achieved, in terms of what we have also previously determined to be the best candidate material to employ in barrier layer 18 (to be discussed further), where adhesive-bonding layer 21 is water-based. A particular and very satisfactory adhesive material in this category we have found to be a water-based liquid product called Simalfa 309, made by Alfa Adhesives, Inc. in Hawthorne, N.J. This material has proven itself to offer very long-term functional stability in the co-active interfacial regions between next-adjacent core-structure layers, such as between layers 16a, 16b. This bonding material, in terms of its solvent base, is incompatible with the solvent base (acetone) which is associated with the particular best-choice material which we select preferably to use for barrier layer 18, in the sense that solvent vapor associated with the barrier layer will not attack the structural integrity of the inner-core-layer adhesive material. Our current preferred choice of barrier-layer material is the previously mentioned product Muraculon PDC F-830.

How layers 18, 21 are preferably prepared during fabrication of the structure of the invention will be described shortly.

Barrier layer 18 which, in the finished product, completely surrounds, encapsulates and envelops core structure 16 in pad 12a is a cured, initially sprayed-on fluid wet layer formed of the product just mentioned above. In general terms, this coating product, which is applied wet and flowable as will later herein be described, and which is based upon acetone as a solvent, cures with solvent evaporation to form a smooth, abrasion-resistant, skin-like protective layer over the outside surfaces of core structure 16. It provides a breathable and durable membrane skin on the outside of the core structure which completely blocks penetration of moisture into the core structure, yet permits relatively free bidirectional gas flow into and out of the core structure. Thus, it permits “breathing” of core structure 16 under circumstances of compression and return-from-compression. Preferably, this barrier layer has a thickness somewhere in the range of about 0.007-inches to about 0.01-inches, and in the specific construction now being described, has a thickness of about 0.009-inches.

In the specific setting of the military helmet now being described for illustration purposes, full “jacketing” of the core cushioning structure by the barrier layer enables the helmet be fully immersible in water without, by virtue of water-immersion, experiencing any degradation in cushioning-material performance, which degradation would result from any moisture entrance into the acceleration-rate-sensitive core material.

As has now been discovered, however, vaporizing of the acetone solvent upon which layer material 18 is based, can initiate, and over extended time, progressively advance, a degradation in the heretofore preferred category of (methylene-chloride-based) interfacial (interlayer) bonding adhesive employed in core structure 16. The presence and progress of such degradation, hidden naturally from view, can advance without pre-warming to a point where, after a sufficiently long time, interactive cooperative cushioning between the cushioning layers is unacceptably degraded.

As has been mentioned, prior to the discovery which has led to the present invention, the bonding adhesive of choice for use in the region intermediate each pair of next-adjacent cushioning layers, has been the methylene chloride solvent product identified above. That choice, an excellent one for many applications, we have, as pointed out earlier, found not to be as effective and preferred in certain other, typically long-term, applications because of the mentioned issue of interlayer debonding. Such debonding—a consequence, we have determined, of a subtle, but nevertheless effective, degradation, due to early and longer term evaporation of solvent in the barrier material—is resolved by the practice and resulting structure of the present invention. Notably, it is resolved without introducing complicated and costly processing or fabrication steps, and without the need for locating or developing a new and differently solvent-based, specialized barrier material.

The improved inter-core-layer adhesive of preferred choice has already been mentioned, and it is readily available. The process of the invention is now described and discussed in the context of a two-layer cushioning core structure.

The materials selected to form the plural core layers are appropriately prepared as sheets suitable for later being pattern-cut, as by dies, into an appropriate group of perimetrally correct cushioning core layers. That surface of the core layer sheet which will most closely face the body-facing side of the protective cushioning interface structure, and that surface face of the other core layer sheet which will most closely face the mentioned, final load-facing side of the structure, are precoated with a spread of the selected barrier material, applied as a flowable wet material. This material may be preferably sprayed into place.

The mentioned water-based adhesive is then applied wet to the opposite surfaces (or to at least one of these surfaces) of these sheets, and the sheets are brought together to enable the establishment of the desired interlayer adhesive bond.

After an appropriate adhesive curing time has passed (typically just a few minutes), the bonded/laminated core-structure materials are cut to shape, and the final edge-directed overcoating of barrier material is sprayed wet into place to form a completed, fully encapsulating barrier around each cut core structure.

Moisture-wicking jacket 20, which, as has been mentioned, does not form any part of the present invention, is then created in any suitable fashion.

Completing now a description of what is further shown in the drawings, pad 12a is anchored to the inside of helmet shell 10a through a two-component conventional hook-and-pile structure 24 typically sold under the name Velcro®—a readily commercially available product made by Velcro USA, Inc., 406 Brown Avenue, Manchester, N.H. 03108-4806. One component of this hook-and-pile structure is suitably joined as by stitching or adhesive bonding to the outside surface of jacket 20 on the load-facing side of pad 12a. The other component of the hook-and-pile structure is suitably joined to the surface (at the appropriate location) of the inside wall in helmet shell 10a. Similar attachment is provided for the other illustrated pads.

As has been pointed out, description of the present invention in the setting of a military helmet provides a good illustration of a use arena in which the importance and significance of the invention can especially be appreciated. From the stand-point of the finally intended capability of a protective cushioning interface structure made in accordance with the invention, cushioning behavior is afforded by the presence of certain surface-bonded and interactively cooperating layers of a non-springy, acceleration-rate-sensitive, viscoelastic-material layers, encapsulated by a moisture-blocking, gas-permeable barrier layer. As has been stated earlier, the practice and implementation of the present invention is aimed at assuring the long-term preservation of cooperative qualities by resolving the recently discovered, possible negative interaction which can occur between the structure of an inter-facial bonding adhesive, and the solvent present in the all-over applied barrier layer. With implementation of the present invention, neither short-term or longer term vaporization of the acetone solvent in the barrier-layer material has any damaging affect on the newly proposed water-based inter-facial bonding adhesive employed between core layers. The invention features a practice wherein the adhesive layer employed to join plural core layers is based upon a solvent of one character, while the barrier layer material is based upon a solvent of another character. The solvent associated with the barrier layer material is incompatible with and does not attack the material of the interfacial bonding adhesive used in the core structure.

In the practice of the invention—its methodology—a cushioning interface structure is fabricated by (a) providing at least a pair of viscoelastic, non-springy, acceleration-rate-sensitive core layers, (b) facially bonding these two core layers using curable and initially wet, flowable adhesive which is based upon a solvent of one character, and thereafter (c) completing the fabrication by the application of a curable, and initially wet, flowable barrier-layer material to form a fully moisture-impervious but gas-permeable coating barrier layer which substantially completely encloses the bonded core layers.

While a preferred and best-mode embodiment of, and manner of practicing, the invention have been described herein, numerous variations thereof are recognized to be possible which will come within the proper scope of the spirit of the invention, as such is set forth in the following claims.

We claim:

1. A method of fabricating a layered, body-protective cushioning interface structure having a body-facing side and a load-facing side, said method comprising
providing at least a pair of viscoelastic, non-springy, acceleration-rate-sensitive core layers
facially bonding these two core layers using curable and initially wet, flowable adhesive which is based upon a solvent of one character, and thereafter
completing the fabrication by the application of a curable, and initially wet, flowable barrier-layer material to form a fully moisture-impervious but gas-permeable coating barrier layer which substantially completely encloses the bonded core layers.

2. The method of claim 1, wherein said bonding is performed utilizing a water-based adhesive, and forming of the barrier layer is performed utilizing an acetone-based barrier-layer material.
